(19) United States
(12) Patent Application Publication
(10) Pub. No.: US 2014/0290841 A1
(43) Pub. Date: Oct. 2, 2014

(54) METHOD FOR MANUFACTURING DISPLAY PANEL

(71) Applicant: InnoLux Corporation, Miao-Li County (TW)

(72) Inventors: Chi-Che TSAI, Miao-Li County (TW); Wei-Yen WU, Miao-Li County (TW); Yu-Ren WANG, Miao-Li County (TW)

(73) Assignee: InnoLux Corporation, Miao-Li County (TW)

(21) Appl. No.: 14/197,159

(22) Filed: Mar. 4, 2014

(30) Foreign Application Priority Data
Mar. 26, 2013 (TW) 102110627

(51) Int. Cl. G02F 1/1333

(52) U.S. Cl. CPC G02F 1/1333
USPC 156/247

(57) ABSTRACT

The present invention provides a method for manufacturing a display panel, comprising the following steps: (A) providing a carrier with a separation layer formed thereon; (B) laminating a glass substrate on the hydrophobic surface of the separation layer to make the separation layer between the carrier and the glass substrate; (C) forming a display unit on the glass substrate; and (D) separating the glass substrate from the carrier and the separation layer to obtain a display panel; wherein the separation layer has a hydrophobic surface with a water contacting angle in a range from 25° to 180°.

### CROSS REFERENCE TO RELATED APPLICATION

This application claims the benefits of the Taiwan Patent Application Serial Number 102110627, filed on Mar. 26, 2013, the subject matter of which is incorporated herein by reference.

### BACKGROUND OF THE INVENTION

1. Field of the Invention

The present invention relates to a method for manufacturing a display panel and, more particularly, to a method for manufacturing a display panel with a thin glass substrate.

2. Description of Related Art

With the rapid development of electronic industry, electronic products are trending towards miniaturization and lightweight. Hence, the thicknesses of glass substrates used for preparing display panels are reduced from 0.4 mm to 0.3 mm.

However, the thin glass substrate with a thickness of 0.3 mm or less does not have enough rigidity. If display units are directly formed on the thin glass substrate to manufacture a display panel, the bending level of the thin glass substrate may exceed the enduring level of the current process for manufacturing the display panel, so that the thin glass substrate cannot be used in the current process.

In order to apply the thin glass substrate into the current process, the thin glass substrate is laminated on a glass carrier having large thickness to increase the rigidity thereof, and it is separated from the glass carrier until the process is finished. However, —Si—O—Si— bonding may be generated between the glass carrier and the thin glass substrate under a high temperature process (>250° C.), and therefore it is hard to separate the thin glass substrate from the glass carrier when the process is completed.

In order to solve the problem of forming the —Si—O—Si— bonding between the glass carrier and the thin glass substrate, another means is to adhere the glass carrier and the thin glass substrate with an adhesive. However, conventional adhesive has poor heat resistance, and the problems of excessive glue and bubbles may also be occurred in the adhesive. Additionally, the adhesive property of the adhesive may cause the problems that it is hardly to separate the thin glass substrate from the glass carrier, or the residue adhesive may remain on the glass carrier after separation; so that the recycle of the glass carrier is not ideal enough.

Therefore, it is desirable to provide a novel method for manufacturing a display panel, which can solve the aforementioned problems and allow thin glass substrates suitable for the current process.

### SUMMARY OF THE INVENTION

An object of the present invention is to provide a method for manufacturing a display panel, in order to fabricate a thin and lightweight display panel.

To achieve the object, the method for manufacturing the display panel comprises the following steps: (A) providing a carrier with a separation layer formed thereon, wherein the separation layer has a hydrophobic surface; (B) laminating a glass substrate on the hydrophobic surface of the separation layer to dispose the separation layer between the carrier and the glass substrate, wherein a thickness of the glass substrate is in a range from 0.1 mm to 0.3 mm; (C) forming a display unit on the glass substrate; and (D) separating the glass substrate from the hydrophobic surface of the separation layer. Herein, the hydrophobic surface of the separation layer has a water contacting angle in a range from 25° to 180°.

In the method for manufacturing the display panel of the present invention, a separation layer with a hydrophobic surface is used. In the case that a glass substrate with a thickness of 0.3 mm or less (herein, also called as a thin glass substrate) is laminated on the carrier, the bonding between the thin glass substrate and the carrier, which is formed during the high temperature process, can be prevented due to the disposition of the separation layer. Meanwhile, in the method for manufacturing the display panel of the present invention, the thin glass substrate is laminated on the separation layer through a vacuum pressing machine or a roller, so that the air therebetween can be removed and a pressure difference is thus formed between two sides of the thin glass substrate. Hence, the thin glass substrate can be firmly laminated on the carrier having the separation layer formed thereon due to atmospheric pressure and static electricity between the thin glass substrate and the separation layer. Since the thin glass substrate is laminated on the separation layer of the carrier through the atmospheric pressure and the electricity therebetween, it is easy to remove the obtained display panel from the carrier only by breaking the vacuum state between the thin glass substrate and the separation layer after the display units are respectively formed on the thin glass substrate, and there are no damages to the thin glass substrate as well as the there are no residues of the separation layer remained on the thin glass substrate.

In the method for manufacturing the display panel of the present invention, the material of the separation layer can be any material generally used in the art, as long as the material has good resistance to high temperature (>250° C.) and the obtained separation layer has hydrophobic functional groups modified thereon or exposed therefrom a surface thereof. Preferably, the material for forming the separation layer has a resistance to a temperature of 600° C. or more. In addition, each of the hydrophobic group can be selected from a group consisting of a substituted or unsubstituted C₁₋₂₀ alkyl group, a substituted or unsubstituted C₂₋₂₀ alkenyl group, a substituted or unsubstituted C₁₋₂₀ alkyl-epoxy group, an epoxy group, and a substituted or unsubstituted C₁₋₂₀ alkyl-acrylic group. Preferably, each of the hydrophobic group is selected from a group consisting of a substituted or unsubstituted C₁₋₁₀ alkyl group, a substituted or unsubstituted C₂₋₁₀ alkenyl group, a substituted or unsubstituted C₁₋₁₀ alkyl-epoxy group, an epoxy group, and a substituted or unsubstituted C₁₋₁₀ alkyl-acrylic group. More preferably, each of the hydrophobic group is selected from a group consisting of a substituted or unsubstituted C₁₋₆ alkyl group, a substituted or unsubstituted C₂₋₆ alkenyl group, a substituted or unsubstituted C₁₋₆ alkyl-epoxy group, an epoxy group, and a substituted or unsubstituted C₁₋₆ alkyl-acrylic group. Most preferably, each of the hydrophobic group is selected from a group consisting of a C₁₋₆ alkyl group, a C₂₋₆ alkenyl group, a C₁₋₆ alkyl-epoxy group, an epoxy group, and a C₁₋₆ alkyl-acrylic group. Herein, the hydrophobic group can be “substituted or unsubstituted”, which means that the alkyl group or the alkenyl group is substituted or unsubstituted with a functional group. Herein, the functional group for substituting hydrogen of the alkyl group or the alkenyl group preferably is a group to provide hydrophobicity, and the examples thereof comprise an epoxy group, a halogen such as Fe and Cl, a thiol group, a mercapto group, and an acyloxy group.

In one aspect of the present invention, the hydrophobic surface of the separation layer is the surface of a polymer layer modified with hydrophobic groups. In this case, the step (A) comprises the following steps: (A11) providing the carrier; (Al2) forming the polymer layer on the carrier; and (A13) modifying the surface of the polymer layer with the hydrophobic groups to form the hydrophobic surface. After the aforementioned steps, the exposed hydroxyl groups (—OH) of the carrier can be covered with the polymer layer, so that the bonding between the carrier and the sequential laminated thin glass substrate is not formed. Herein, the material of the polymer layer is not particularly limited, as long as it has the property of good resistance to the high temperature (>250 ° C.), and the example thereof comprises polyimide (PI).

In another aspect of the present invention, the separation layer is an organic-inorganic material layer with hydrophobic groups exposed from a surface thereof. In this case, the step (A) comprises the following steps: (A21) providing the carrier; (A22) forming the organic-inorganic material layer on the carrier, wherein the organic-inorganic material layer has hydrophobic groups and reacting groups, and the hydrophobic groups of the organic-inorganic material layer exposed from the surface of the organic-inorganic material layer to form the hydrophobic surface; and (A23) performing a reduction reaction to react the reacting groups in the organic-inorganic material layer with hydroxyl groups (—OH) of the carrier. After the aforementioned steps, the reacting groups of the organic-inorganic material layer can react with the exposed hydroxyl group of the carrier to form bonding (i.e. —Si—O—X—, wherein X can be Si, Ti or Al), and therefore no bonding is formed between the sequential laminated thin glass substrate and the carrier.

Herein, the organic-inorganic material layer is made of a compound represented by the following formula (I):

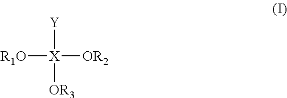

wherein each of R₁, R₂ and R₃ is independently a substituted or unsubstituted C₁₋₆ alkyl group; Y is selected from a group consisting of a substituted or unsubstituted C₁₋₂₀ alkyl group, a substituted or unsubstituted C₂₋₂₀ alkenyl group, a substituted or unsubstituted C₁₋₂₀ alkyl-epoxy group, an epoxy group, and a substituted or unsubstituted C₁₋₂₀ alkyl-acrylic group; and X is Si, Ti or Al. Herein, Y is the aforementioned hydrophobic group. In addition, X preferably is Si.

In this aspect, the organic-inorganic material layer can be made of a material selected from a group consisting of (3-glycidoxypropyl)trimethoxysilane, 3-chloropropyltriethoxysilane, 3-chloropropyltrimethoxysilane, 3-mercaptopropyltriethoxysilane, 3-mercaptopropyltrimethoxysilane, chloromethyltriethoxysilane, chloromethyltrimethoxysilane, methacryloxypropyltrimethoxysilane, trifluoropropyltrimethoxysilane, vinyltriethoxysilane, vinyltrimethoxysilane, vinyltris(2-methoxyethoxy)silane, and vinyltris(methylethylketoximino)silane.

In the method for manufacturing the display panel of the present invention, the glass substrate is laminated on the hydrophobic surface of the separation layer through a vacuum pressing machine or a roller (i.e. a rolling machine) in the step (B). In addition, in the step (D), the vacuum state between the separation layer of the carrier and the thin glass substrate with the display units formed thereon can be broken by using a steel pin and optionally along with an auxiliary plate. More specifically, when the thin glass substrate with the display units formed thereon is separated from the carrier and the separation layer, the step (D) may comprise the following steps: (D1) attaching an auxiliary plate on a side of the carrier opposite to a side thereof with the separation layer formed thereon; and (D2) separating the glass substrate from the carrier and the separation layer through the auxiliary plate to obtain the display panel. Herein, the auxiliary plate can be adhered to the side of the carrier opposite to a side thereof with the separation layer formed thereon through an adhesive layer. More specifically, the auxiliary plate can be a plate having an adhesive layer formed on one side thereof, and it can be directly adhered onto the carrier through the adhesive layer. Alternatively, the auxiliary plate is a thin plate, and an adhesive layer and the auxiliary plate are sequentially laminated on the carrier. Preferably, the area of the auxiliary plate is larger than that of the carrier, so the glass substrate and the display units can be separated from the carrier and the separation layer more easily.

In the method for manufacturing the display panel of the present invention, the hydrophobic surface of the separation layer may have a water contacting angle in a range from 25° to 180°. Preferably, the water contacting angle thereof is in a range from 45° to 90°.

In addition, in the method for manufacturing the display panel of the present invention, the thickness of the separation layer is not particularly limited, as long as it can prevent the reaction between the hydroxyl groups of the carrier and those of the glass substrate. For example, the thickness of the separation layer can be in a range from 100 Å to 2000 Å.

Furthermore, the thickness of the glass substrate used in the method of the present invention can be 0.3 mm or less. Preferably, the thickness thereof is in a range from 0.1 mm to 0.3 mm.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view showing a carrier, a separation layer and a glass substrate according to Embodiment 1 of the present invention;

FIG. 2 is a perspective view showing a reaction between a carrier and a separation layer according to Embodiment 1 of the present invention;

FIG. 3 is a perspective view showing a carrier, a separation layer and a glass substrate according to Embodiment 2 of the present invention;

FIG. 4 is a perspective view showing a reaction of hydrophobic groups of a separation layer according Embodiment 2 of the present invention; and

FIGS. 5A-5I are cross-sectional views showing a process for manufacturing a display panel according to Embodiment 3 of the present invention.

### DETAILED DESCRIPTION OF THE PREFERRED EMBODIMENT

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

### Embodiment 1

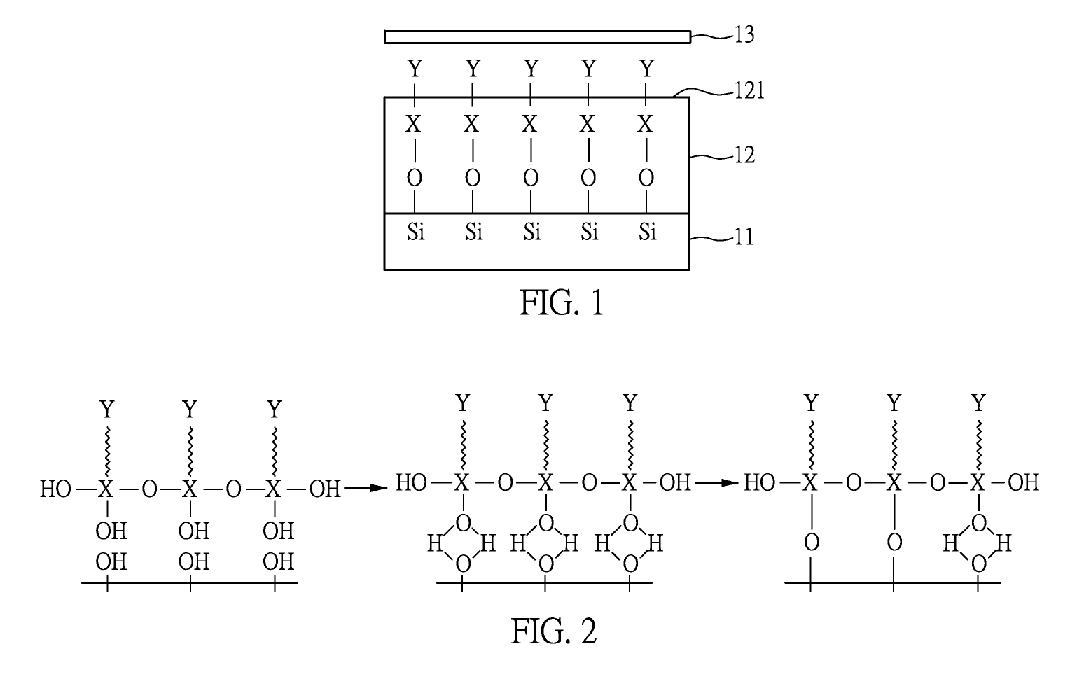

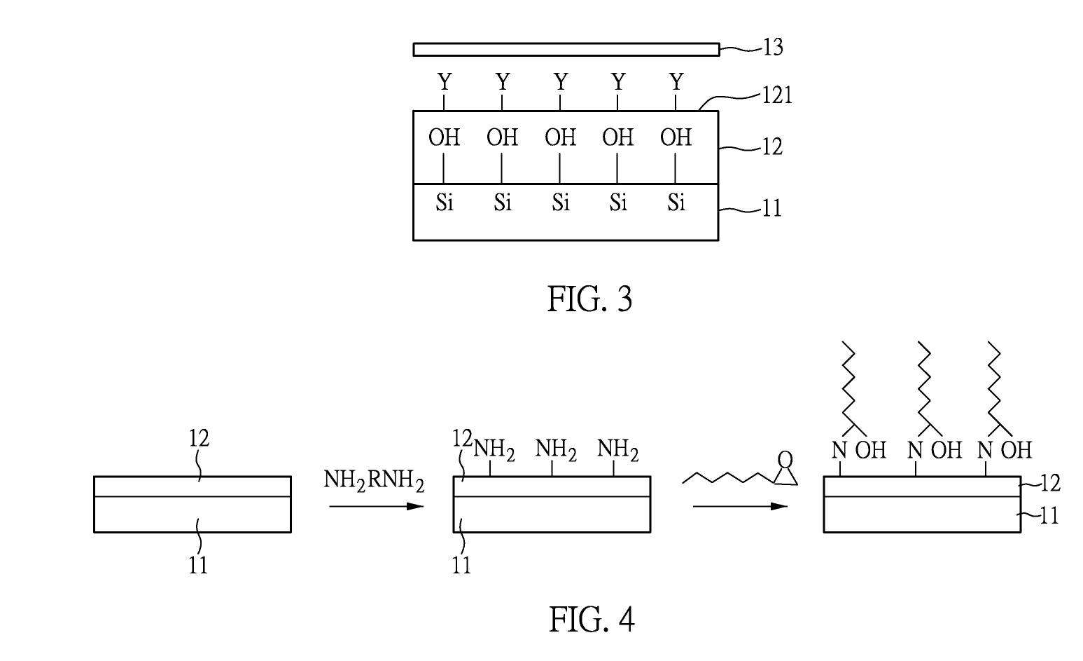

Please refer to FIG. 1 and FIG. 2, wherein FIG. 1 is a perspective view showing a carrier, a separation layer and a glass substrate of the present embodiment, and FIG. 2 is a perspective view showing a reaction between a carrier and a separation layer.

In the conventional process for manufacturing a display panel, an ozone ashing process is performed to wash a carrier and a glass substrate before manufacturing a display panel. After the ozone ashing process, hydroxyl groups (—OH) are formed on surfaces of the carrier and the glass substrate. If the glass substrate with the hydroxyl groups is laminated on the carrier with the hydroxyl groups directly, the sequential high temperature process (>250° C.) may cause the hydroxyl groups of the carrier and the glass substrate to react with each other to form —Si—O—Si— bonding, and this bonding may cause the situation that the glass substrate cannot be separated from the carrier easily.

In order to solve the aforementioned problem, as shown in FIG. 1, a separation layer 12 is firstly formed on a carrier 11 after the carrier 11 is washed, and then a glass substrate 13 is laminated on the carrier 11. Herein, the separation layer 12 has a hydrophobic surface 121, which has a water contacting angle in a range from 25° to 180°.

Hereinafter, the material of the separation layer 12 and the process for preparing the same are described in detail.

Please refer to FIG. 1 and FIG. 2. First, a cleaned carrier 11 is provided, wherein the carrier 11 is a glass carrier or a silicon substrate, and hydroxyl groups are exposed from a surface thereof, as shown in the left side of the reaction scheme of FIG. 2. Next, a separation layer 12 is formed on the carrier, which can be formed by any coating process generally used in the art, such as a dip coating process, a roll coating process, a printing process and a spin coating process.

In the present embodiment, the compound represented by the following formula (I) can be used to form the separation layer 12:

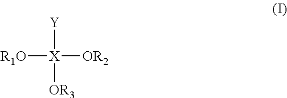

wherein each of R₁, R₂ and R₃ is independently a substituted or unsubstituted C₁₋₆ alkyl group; X is Si, Ti or Al; and Y is a hydrophobic group such as a substituted or unsubstituted C₁₋₂₀ alkyl group, a substituted or unsubstituted C₂₋₂₀ alkenyl group, a substituted or unsubstituted C₁₋₂₀ alkyl-epoxy group, an epoxy group, and a substituted or unsubstituted C₁₋₂₀ alkyl-acrylic group. Preferably, each of the hydrophobic group is selected from a group consisting of a substituted or unsubstituted C₁₋₁₀ alkyl group, a substituted or unsubstituted C₂₋₁₀ alkenyl group, a substituted or unsubstituted C₁₋₁₀ alkyl-epoxy group, an epoxy group, and a substituted or unsubstituted C₁₋₁₀ alkyl-acrylic group. More preferably, each of the hydrophobic group is selected from a group consisting of a substituted or unsubstituted C₁₋₆ alkyl group, a substituted or unsubstituted C₂₋₆ alkenyl group, a substituted or unsubstituted C₁₋₆ alkyl-epoxy group, an epoxy group, and a substituted or unsubstituted C₁₋₆ alkyl-acrylic group. Most preferably, each of the hydrophobic group is selected from a group consisting of a C₁₋₆ alkyl group, a C₂₋₆ alkenyl group, a C₁₋₆ alkyl-epoxy group, an epoxy group, and a C₁₋₆ alkyl-acrylic group. Herein, the hydrophobic group can be “substituted or unsubstituted”, which means that the alkyl group or the alkenyl group is substituted or unsubstituted with a functional group. Herein, the functional group for substituting hydrogen on the alkyl group or the alkenyl group preferably is preferably a group to provide hydrophobicity, and the examples thereof comprise an epoxy group, a halogen such as Fe and Cl, a thiol group, a mercapto group, and an acyloxy group.

Preferably, the compound of the formula (I) is a silane-based compound, such as (3-glycidoxypropyl)trimethoxysilane, 3-chloropropyltriethoxysilane, 3-chloropropyltrimethoxysilane, 3-mercaptopropyltriethoxysilane, 3-mercaptopropyltrimethoxysilane, chloromethyltriethoxysilane, chloromethyltrimethoxysilane, methacryloxypropyltrimethoxysilane, trifluoropropyltrimethoxysilane, vinyltriethoxysilane, vinyltrimethoxysilane, vinyltris(2-methoxyethoxy)silane, vinyltris(methylethylketoximino)silane.

The compound of the formula (I) may undergo a hydrolysis process under an water-containing environment to form a compound represented by the following formula (II), which further self-condenses into a compound represented by the following formula (III):

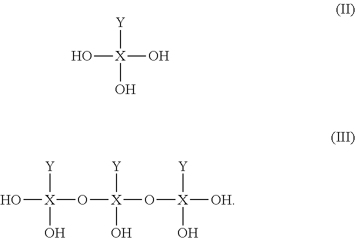

Hence, when the carrier 11 is coated with the compound of the formula (I), the hydroxyl groups formed from the compound of the formula (I) can be used as reactive functional groups to react with those of the carrier 11 after the hydrolysis and the self-condensation reaction thereof, as shown in the formula (III) as well as the middle and the left side of the reaction scheme of FIG. 2. Then, parts or all of the hydroxyl groups are hydrolyzed and condensed to form —O— bonding, as shown in the right side of the reaction scheme of FIG. 2.

Since the hydrophobic groups Y of the formula (I) cannot react with the carrier 11, they are exposed from the surface of the separation layer 12 to form a hydrophobic surface 121, as shown in FIG. 1.

In addition, since the hydrophobicity is related to the adhesion between the separation layer 12 and the glass substrate 13, the ratio of the exposed hydrophobic groups Y can be adjusted by modulating the dilution ratio of the compound of the formula (I) and the used solvent or selectively performing an irradiation process on the separation layer 12 to break the bonding between the groups X and the hydrophobic groups Y, to control the hydrophobicity (i.e. water contacting angle) of the hydrophobic surface 121 and facilitate the sequential separation process between the separation layer 12 and the glass substrate 13.

After the aforementioned process, the carrier 11 with the separation layer 12 formed thereon can be obtained, wherein the separation layer 12 has a hydrophobic surface 121 formed by the hydrophobic groups Y exposed therefrom, as shown in FIG. 1.

### Embodiment 2

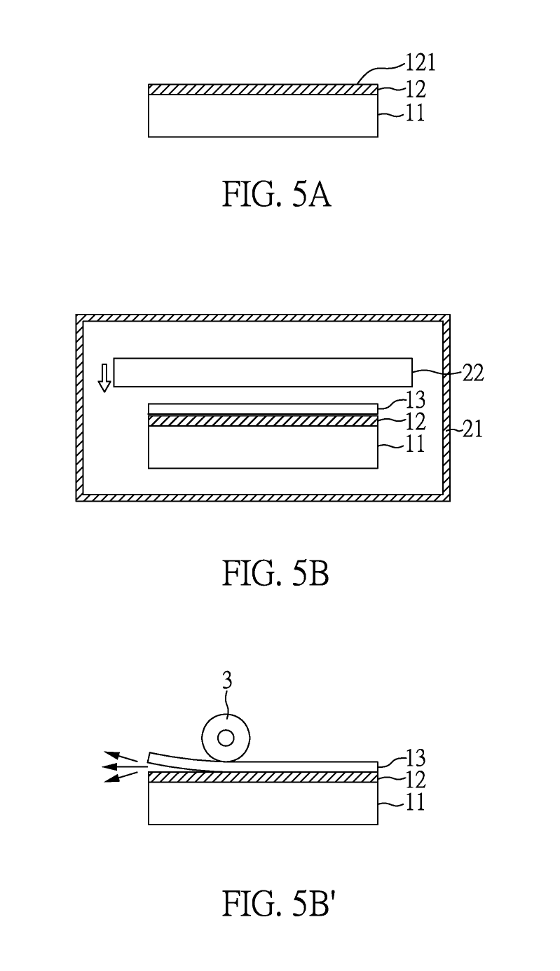

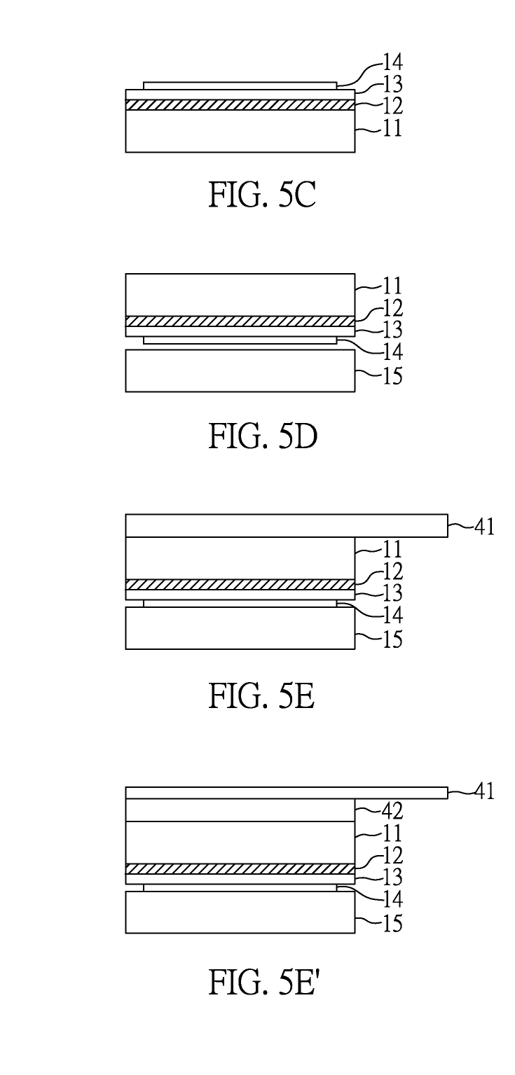

Please refer to FIG. 3 and FIG. 4, wherein FIG. 3 is a perspective view showing a carrier, a separation layer and a glass substrate of the present embodiment, and FIG. 4 is a perspective view showing a reaction of hydrophobic groups of a separation layer.

The structure and the process of the present embodiment are the same as those described in Embodiment 1, except that the compound of the formula (I) in Embodiment 1 is replaced with a polymer to form the separation layer 12 of the present embodiment. Hereinafter, the material of the separation layer 12 of the present embodiment and the process for preparing the same are described in detail.

First, a separation layer 12 is formed on a carrier 11 through the same process used in Embodiment 1 to cover the exposed hydroxyl groups of the carrier 11, as shown in FIG. 3 and the left side of the reaction scheme of FIG. 4. Herein, the separation layer 12 is a polymer layer. Next, any surface treatment generally used in the art is performed on the separation layer 12 to modify a surface thereof, wherein specific examples of the surface treatment comprises ionized gas treatment, UV irradiation, or wet chemical treatment. In the present embodiment, the surface of the separation layer 12 is modified with amino groups (—NH₂) through the wet chemical treatment. Then, the amino group-containing surface of the separation layer 12 is further modified with hydrophobic groups (such as a substituted or unsubstituted C₁₋₂₀ alkyl group, a substituted or unsubstituted C₂₋₂₀ alkenyl group, a substituted or unsubstituted C₁₋₂₀ alkyl-epoxy group, an epoxy group, or a substituted or unsubstituted C₁₋₂₀ alkyl-acrylic group) through a further wet chemical treatment, and therefore the separation layer 12 has a hydrophobic surface 121 formed by the hydrophobic groups Y exposed therefrom, as shown in FIG. 3. In the present embodiment, the separation layer 12 is modified with C₈-alkyl groups as the hydrophobic groups Y, as shown in FIG. 3 and the right side of the reaction scheme of FIG. 4.

After the aforementioned process, the carrier 11 with the separation layer 12 formed thereon can be obtained, wherein the separation layer 12 has a hydrophobic surface 121 formed by the hydrophobic groups Y exposed therefrom, as shown in FIG. 3.

### Embodiment 3

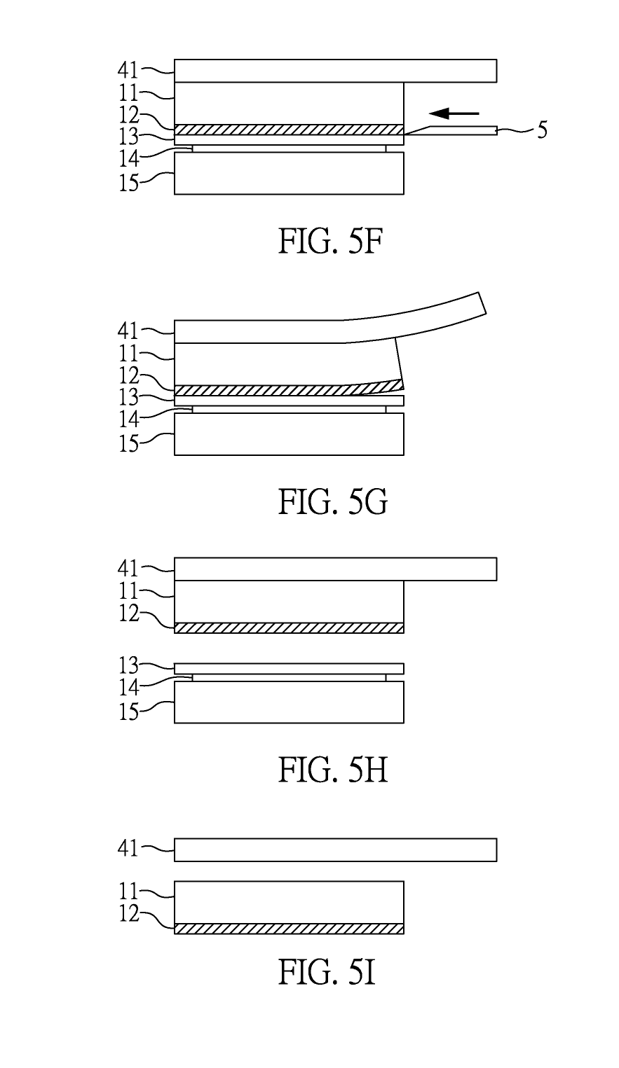

FIGS. 5A-5I are cross-sectional views showing a process for manufacturing a display panel in the present embodiment.

First, as shown in FIG. 5A, a carrier 11 with a separation layer 12 formed thereon is provided, wherein the separation layer 12 has a hydrophobic surface with a water contacting angle in a range from 25° to 180°, and the carrier 11 is a glass carrier or a silicon substrate. The thickness of the separation layer 12 is not particularly limited, as long as it can completely cover the hydroxyl groups of the carrier 11. Preferably, it is in a range from 100 Å to 2000 Å. In the present embodiment, the separation 12 can be one of the separation layer described in Embodiment 1 or Embodiment 2, so the structure and the material thereof are not described in detail herein.

Next, as shown in FIGS. 5B and 5B′, a glass substrate 13 is laminated on the hydrophobic surface 121 (as shown in FIG. 5A) of the separation layer 12 to allow the separation layer 12 to be disposed between the carrier 11 and the glass substrate 13. Herein, the thickness of the glass substrate 13 is 0.3 mm or less. Preferably, the thickness thereof is in a range from 0.1 mm to 0.3 mm.

As shown in FIG. 5B, the glass substrate 13 can be laminated on the separation layer 12 with a pressing unit 22 in a vacuum chamber 21, and this process is the so-called vacuum pressing process. Alternatively, as shown in FIG. 5B′, the glass substrate 13 is laminated on the separation layer 12 with a roller 3 to remove air therebetween, and this process is the so-called roll laminating process. However, in either the vacuum pressing process or the roll lamination process, the air between the glass substrate 13 and the separation layer 12 is removed to form a pressure difference between two sides of the glass substrate 13. Therefore, the glass substrate 13 can be firmly laminated on the carrier 12 via atmospheric pressure and static electricity between the glass substrate 13 and the separation layer 12.

Next, as shown in FIG. 5C, a display unit 14 is formed on the glass substrate 13 through the conventional process used in the art. Herein, the display unit 14 may comprise any active unit or passive unit generally used in the display field of the related art, such as a thin-film transistor, a color filter, an organic light emitting diode and a touch panel. The structure of each display unit is known by persons skilled in the art and not described in detail herein.

As shown in FIG. 5D, the glass substrate 13 with the display unit 14 formed thereon is assembled with a module 15, which may be another glass substrate or comprise any active unit or passive unit generally used in the display field of the related art, such as a thin-film transistor, a color filter, an organic light emitting diode and a touch panel. Herein, the types of the module 15 and the display unit 14 can be selected based on the designs and the manufacturing processes, as long as a display panel can be obtained after assembly.

Next, as shown in FIGS. 5E and 5E′, an auxiliary plate 41 is attached on a side of the carrier 11 opposite to a side thereof with the separation layer 12 formed thereon. Herein, as shown in FIG. 5E, the auxiliary plate 41 can be a plate having an adhesive layer (not shown in the figure) formed on one side thereof, and it can be directly adhered onto the another of the carrier 11 opposite to the side thereof with the separation layer 12 formed thereon through the adhesive layer. Alternatively, the auxiliary plate 41 is a thin plate, and an adhesive layer 42 and the auxiliary plate 41 are sequentially laminated onto another side of the carrier 11 opposite to the side thereof with the separation layer 12 formed thereon.

Herein, the auxiliary plate 41 is not particularly limited, and can be a metal plate, a plastic plate or a plate made of other material. The material of the adhesive layer 42 is also not particularly limited, as long as it can provide the adhesive property. Herein, the material of the adhesive layer 42 can be UV gel or foaming gel. In addition, the area of the auxiliary plate 41 is larger than that of the carrier 11, to facilitate the separation of the display panel from the carrier 11.

Hereinafter, the sequential process is demonstrated according to the aspect shown in FIG. 5E. As shown in FIG. 5F, a scraper 5 such as a steel pin is inserted between the glass substrate 13 and the separation layer 12 to break the vacuum state therebetween. Then, as shown in FIG. 5G, the glass substrate 13 and the display unit 14 are separated from the carrier 11 and the separation layer 12 with the auxiliary plate 14, to obtain the display panel of the present embodiment, as shown in FIG. 5H. In the present embodiment, the display panel is separated from the carrier 11 with the auxiliary plate 41. However, in other embodiments, since the vacuum state between the glass substrate 13 and the separation layer 12 is broken, the pressure difference therebetween is eliminated; and therefore the display panel can be directly separated from the carrier without using the auxiliary plate 41.

Finally, as shown in FIG. 5I, an UV irradiation or a heating process may be selectively performed on the auxiliary plate 41 to separate the same from the carrier 11 to recycle the carrier 11.

The method for manufacturing the display panel of the present embodiment can be applied to various display panels, such as liquid crystal display panels (LCDs) or organic light emitting diode display panels (OLEDs). In addition, the obtained display panels can further be applied to various electronic devices, such as cell phones, notebooks, video cameras, cameras, music players, navigation devices, and televisions.

### Testing Example

Water contacting angles of separation layers made of different material are examined to understand the hydrophobicity thereof. In the present testing example, glass substrates are coated with silane compounds through a spin coating process to form separation layers. The types of the used silane compounds and the dilution ratio in solvents are listed in the following Table 1.

After examination, the water contacting angles of the obtained separation layers made of different silane compound are listed in the following Table 1, which are examined by JIS R3257.

TABLE 1

| Type of | | | Water |
|---|---|---|---|
| the silane | Name of the silane | Dilution ratio | contacting |
| compound | compound | (solvent) | angle (°) |
| Alkyl | Methyltri-methoxysilane | Stock solution | 78 |
| | | (without | |
| | | dilution) | |
| Vinyl | Vinyltrimethoxysilane | Stock solution | 41.5 |
| | | (without | |
| | | dilution) | |
| Epoxy | Glycidylpropyl- | Stock solution | 57 |
| | trimethoxysilane | (without | |
| | | dilution) | |
| | | 1:20 (H₂O) | 40.9 |
| | | 1:40 (H₂O) | 34.9 |
| | | 1:60 (H₂O) | 28.1 |
| Methacryl | Methacryloxy- | Stock solution | 67.65 |
| | propyltrimethoxysilane | (without | |
| | | dilution) | |
| | | 1:20 (NMP) | 55.52 |
| | | 1:40 (NMP) | 50.7 |
| | | 1:60 (NMP) | 44.55 |

NMP: N-methyl pyrrolidinone

From the results shown in Table 1, the separation layer has a hydrophobic surface having a water contacting angle in a range from 25° to 180° when the silane compounds having hydrophobic groups are used to prepare the separation layer. If an ideal hydrophobicity is required, the material, which can form a separation layer with a hydrophobic surface having a water contacting angle in a range from 45° to 90°, can be selected.

Although the present invention has been explained in relation to its preferred embodiment, it is to be understood that many other possible modifications and variations can be made without departing from the spirit and scope of the invention as hereinafter claimed.

What is claimed is:

1. A method for manufacturing a display panel, comprising the following steps:
(A) providing a carrier with a separation layer formed thereon, wherein the separation layer has a hydrophobic surface;
(B) laminating a glass substrate on the hydrophobic surface of the separation layer to dispose the separation layer between the carrier and the glass substrate, wherein a thickness of the glass substrate is in a range from 0.1 mm to 0.3 mm;
(C) forming a display unit on the glass substrate; and
(D) separating the glass substrate from the hydrophobic surface of the separation layer,
wherein the hydrophobic surface of the separation layer has a water contacting angle in a range from 25° to 180°.

2. The method as claimed in claim 1, wherein the hydrophobic surface of the separation layer is the surface of a polymer layer modified with hydrophobic groups, and each of the hydrophobic group is selected from a group consisting of a substituted or unsubstituted C₁₋₂₀ alkyl group, a substituted or unsubstituted C₂₋₂₀ alkenyl group, a substituted or unsubstituted C₁₋₂₀ alkyl-epoxy group, an epoxy group, and a substituted or unsubstituted C₁₋₂₀ alkyl-acrylic group.

3. The method as claimed in claim 2, wherein the step (A) comprises the following steps:
(A11) providing the carrier;
(Al2) forming the polymer layer on the carrier; and
(A13) modifying the surface of the polymer layer with the hydrophobic groups to form the hydrophobic surface.

4. The method as claimed in claim 1, wherein the separation layer is an organic-inorganic material layer with hydrophobic groups exposed from the surface thereof, and each of the hydrophobic group is a substituted or unsubstituted C₁₋₂₀ alkyl group or a substituted or unsubstituted C₂₋₂₀ alkenyl group.

5. The method as claimed in claim 4, wherein the step (A) comprises the following steps:
(A21) providing the carrier;
(A22) forming the organic-inorganic material layer on the carrier, wherein the organic-inorganic material layer has hydrophobic groups and reacting groups, and the hydrophobic groups exposed from the surface of the organic-inorganic material layer to form the hydrophobic surface; and
(A23) performing a reduction reaction to react the reacting groups in the organic-inorganic material layer with hydroxyl groups (—OH) of the carrier.

6. The method as claimed in claim 4, wherein the organic-inorganic material layer is made of a compound represented by the following formula (I): 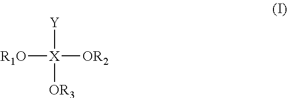
wherein each of R₁, R₂ and R₃ is independently a substituted or unsubstituted C₁₋₆ alkyl group; Y is selected from a group consisting of a substituted or unsubstituted C₁₋₂₀ alkyl group, a substituted or unsubstituted C₂₋₂₀ alkenyl group, a substituted or unsubstituted C₁₋₂₀ alkyl-epoxy group, an epoxy group, and a substituted or unsubstituted C₁₋₂₀ alkyl-acrylic group; and X is Si, Ti or Al.

7. The method as claimed in claim 6, wherein a functional group for substituting the C₁₋₂₀ alkyl group or the C₂₋₂₀ alkenyl group is selected from a group consisting of an epoxy group, a halogen, a thiol group, a mercapto group, and an acyloxy group.

8. The method as claimed in claim 4, wherein the organic-inorganic material layer is made of a material selected from a group consisting of (3-glycidoxypropyl)trimethoxysilane, 3-chloropropyltriethoxysilane, 3-chloropropyltrimethoxysilane, 3-mercaptopropyltriethoxysilane, 3-mercaptopropyltrimethoxysilane, chloromethyltriethoxysilane, chloromethyltrimethoxysilane, methacryloxypropyltrimethoxysilane, trifluoropropyltrimethoxysilane, vinyltriethoxysilane, vinyltrimethoxysilane, vinyltris(2-methoxyethoxy)silane, and vinyltris(methylethylketoximino)silane.

9. The method as claimed in claim 1, wherein the hydrophobic surface of the separation layer has a water contacting angle in a range from 45° to 90°.

10. The method as claimed in claim 1, wherein the glass substrate is laminated on the hydrophobic surface of the separation layer through a vacuum pressing machine or a roller in the step (B); and the step (D) comprises the following steps:
(D1) attaching an auxiliary plate on a side of the carrier opposite to a side thereof with the separation layer formed thereon; and
(D2) separating the glass substrate from the carrier and the separation layer through the auxiliary plate to obtain the display panel.
